(19) United States
(12) Patent Application Publication
(10) Pub. No.: US 2016/0121498 A1
(43) Pub. Date: May 5, 2016

(54) SHAVING RAZOR SYSTEM INCLUDING AT LEAST ONE MAGNETIC ELEMENT

(71) Applicant: The Gillette Company, Boston, MA (US)

(72) Inventor: Robert Harold Johnson, Hingham, MA (US)

(21) Appl. No.: 14/528,382

(22) Filed: Oct. 30, 2014

(51) Int. Cl. B26B 21/52; B26B 21/40; B26B 21/22

(52) U.S. Cl. CPC B26B 21/521; B26B 21/225; B26B 21/4012

(57) ABSTRACT

The invention is directed toward a shaving razor system. The shaving razor system has a handle and a removable razor cartridge. The handle has a proximal end portion, a distal end portion, and at least one magnetic handle element that is in pivotable relation to the proximal end portion. The removable razor cartridge has a housing, a guard, a cap, and at least one blade. The removable razor cartridge is releasably engaged with the at least one magnetic handle element to replaceably secure the removable razor cartridge to the proximal end portion of the handle.

### FIELD OF THE INVENTION

The present invention relates to a shaving razor system, and more particularly to a shaving razor system including at least one magnetic element.

### BACKGROUND OF THE INVENTION

Most wet shaving systems available today use removable razor cartridges that attach to a handle. After a blade within the removable razor cartridge becomes dull, the removable razor cartridge may be disposed of and a new removable razor cartridge may be attached to the handle. A variety of techniques have been used for attaching removable razor cartridges to handles. One example includes a dovetail coupling arrangement between the handle and removable razor cartridge to fix the cartridge on the handle at a desired angle. In addition, some techniques include attaching the removable razor cartridge to the handle in a way that allows the removable razor cartridge to pivot in a controlled manner, about its major axis. Pivotal attachment of the removable razor cartridge allows the blade mounted in the removable razor cartridge to follow skin surface contours independently of the handle orientation. The removable razor cartridge is pivotable between limits and ordinarily is biased toward a preferred neutral angular position vis-a-vis the handle. Furthermore, other designs have been developed that rely on a temporary mechanical interlock to secure the removable razor cartridge to the handle. Such arrangements may be relatively bulky in appearance and are costly to manufacture and assemble. Also, safety and performance concerns exist should the user inappropriately connect the removable razor cartridge to the razor handle. The user, for example, may reverse the connection of the removable razor cartridge to the razor handle. Such an arrangement may, at least, lead to a poor shaving experience and may, at worst, lead to injury to the user. There is a need to provide a removable razor cartridge that is capable of quick, easy, intuitive, and safe attachment to a handle. In addition, there is a need to provide a removable razor cartridge that is pivotable, but that is also less complex and less costly to manufacture and assemble.

### SUMMARY OF THE INVENTION

In one embodiment, the invention is directed toward a shaving razor system. The shaving razor system has a handle and a removable razor cartridge. The handle has a proximal end portion, a distal end portion, and at least one magnetic handle element that is in pivotable relation to the proximal end portion. The removable razor cartridge has a housing, a guard, a cap, and at least one blade. The removable razor cartridge is releasably engaged with the at least one magnetic handle element to replaceably secure the removable razor cartridge to the proximal end portion of the handle.

### DETAILED DESCRIPTION OF THE DRAWINGS

The details of one or more embodiments of the invention are set forth in the accompanying drawings and the description below. It is understood that certain embodiments may combine elements or components of the invention, which are disclosed in general, but not expressly exemplified or claimed in combination, unless otherwise stated herein. Other features and advantages of the invention will be apparent from the description and drawings, and from the claims.

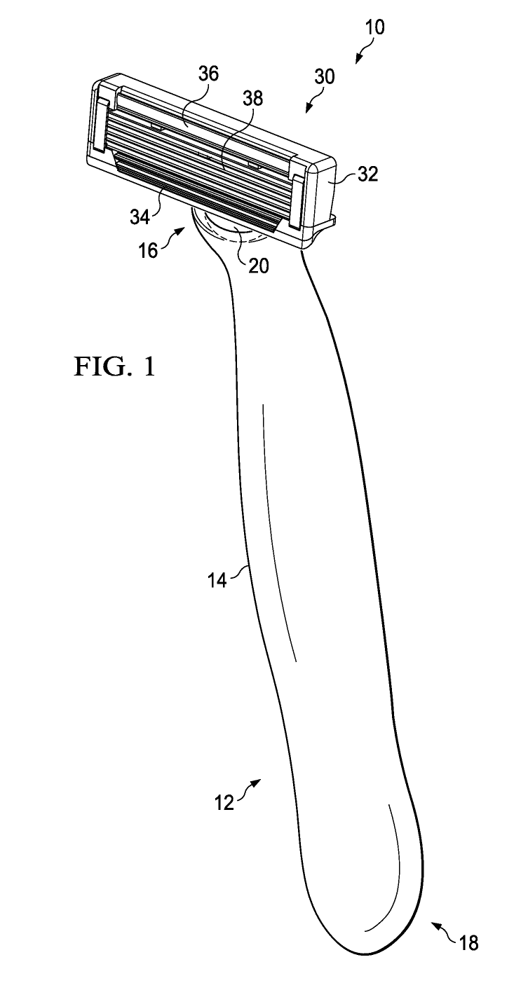

FIG. 1 is a perspective view of an embodiment of a shaving razor system including at least one magnetic element.

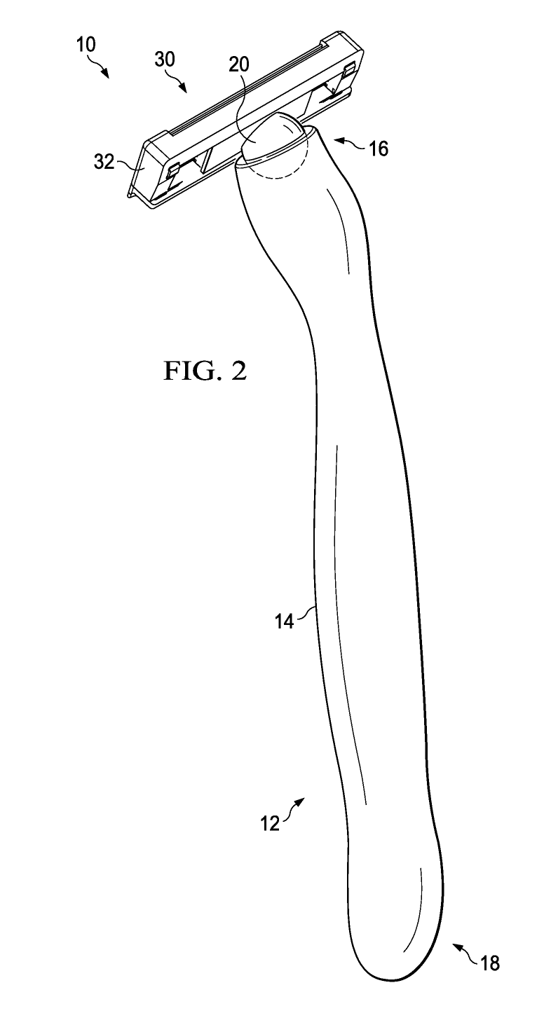

FIG. 2 is another perspective view of the embodiment of a shaving razor system including at least one magnetic element that is shown in FIG. 1.

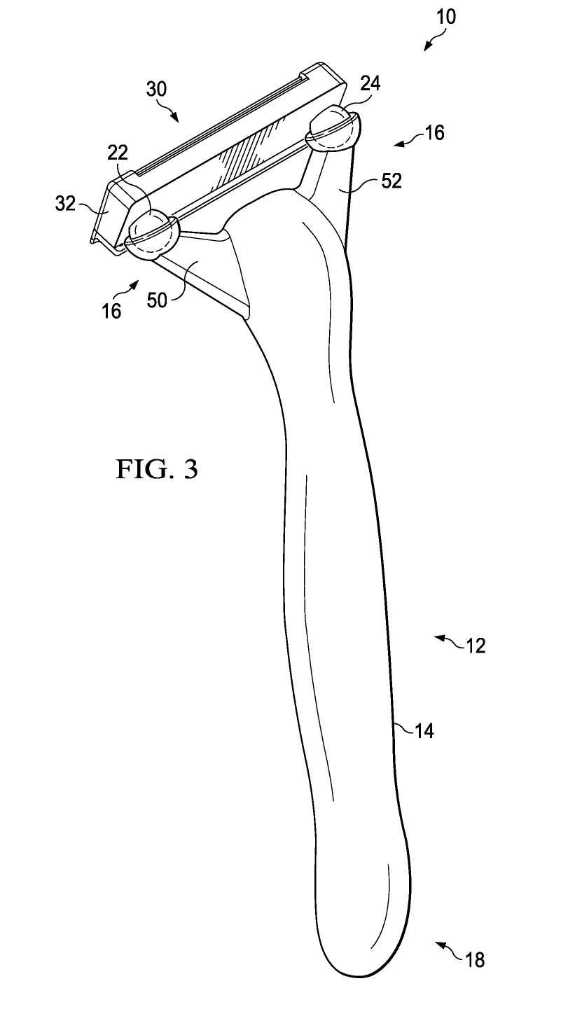

FIG. 3 is a perspective view of another embodiment of a shaving razor system including at least one magnetic element.

### DETAILED DESCRIPTION OF THE INVENTION

A shaving razor system may include a handle and a removable razor cartridge. The handle may include a proximal end portion, a distal end portion, and at least one magnetic handle element that is in pivotable relation to the proximal end portion. The removable razor cartridge may include a housing, a guard, a cap, and at least one blade. The removable razor cartridge may be releasably engaged with the at least one magnetic handle element to replaceably secure the removable razor cartridge to the proximal end portion of the handle. The at least one magnetic handle element may pivot about an axis that is generally transverse to the handle.

The handle may be of any suitable shape. The handle, for example, may be an elongated barrel shape or may be a contoured shape. The handle may include an elongated gripping portion. The handle may include two or more arms. The two or more arms may be located at the proximal end of the handle. The two or more arms may be spaced apart from one another. The handle may be, for example, an elongated barrel shape that includes two arms that are spaced apart and that are located at the proximal end of the handle. The handle may be, for example, a contoured shape that includes two arms that are spaced apart and that are located at the proximal end of the handle. The handle may be made from any suitable material. The handle may be made, for example, from a polymer, an elastomer, a plastic, a thermoplastic, a rubber, any other suitable material, or any combination thereof. The handle may be made by any suitable process. The handle may be made, for example, by molding, injection molding, insert injection molding, casting, extruding, any other suitable method, or any combination thereof.

The handle may include at least one magnetic handle element. The handle may include, for example, one magnetic handle element, two magnetic handle elements, three magnetic handle elements, or any number of magnetic handle elements. The handle may include at least two magnetic handle elements that are spaced apart. For example, the handle may include two magnetic handle elements that are spaced apart, three magnetic elements that are spaced apart, four magnetic elements that are spaced apart, or any number of magnetic elements that are spaced apart. The two or more magnetic handle elements that are spaced apart may be located on, for example, the two or more arms of the handle.

The at least one magnetic handle element may exhibit a magnetic property or combination of magnetic properties. For example, the at least one magnetic handle element may include a permanent magnet, a dipole magnet, an electromagnet, a ferromagnetic material, a magnetized ferromagnetic material, a positive pole, a negative pole, or any combination thereof. The at least one magnetic handle element may, for example, be a magnetic element that exerts an attractive magnetic force. The at least one magnetic handle element may be, for example, a magnetic element that is attracted by a magnetic force.

The at least one magnetic handle element may be of any suitable material that exhibits at least one of aforementioned magnetic properties. The at least one magnetic handle element may, for example, comprise at least one of iron, nickel, aluminum, cobalt, boron, alnico, ferrite, gadolinium, dysprosium, samarium, samarium-cobalt, neodymium-iron-boron, any alloy thereof, any ceramic thereof, or any combination thereof.

The at least one magnetic handle element may be of any suitable size and shape. For example, the at least one magnetic handle element may comprise a curved surface, a flat surface, or any combination thereof. The at least one magnetic handle element may, for example, comprise a sphere, an ellipsoid, a cylinder, a quadrilateral, a parallelogram, a rectangle, a square, a bar, or any combination thereof. In addition, the at least one magnetic handle element may also be plated or coated (e.g., with plastic, rubber or nickel) to resist corrosion caused by the shaving environment.

The at least one magnetic handle element may be in pivotable relation to the proximal end portion of the handle. The at least one magnetic handle element may be in pivotable relation to the proximal end portion of the handle via, for example, a joint, a hinge, or any other suitable connection that enables the at least one magnetic handle element to be in pivotable relation to the proximal end portion of the handle. The at least one magnetic handle element may be in pivotable relation to the proximal end portion of the handle via a revolute joint, a revolute hinge, a prismatic slider, a prismatic joint, a cylindrical joint, a spherical joint, a ball-and-socket joint, a planar joint, a slot joint, a reduced slot joint, or any other suitable joint, or any other suitable hinge. The at least one magnetic handle element may be in pivotable relation to the proximal end portion of the handle by, for example, co-injection molding the at least one magnetic handle element with the handle. Other known assembly methods to connect the at least one magnetic handle element within the handle may also be used such as press fitting, force fitting.

The at least one blade of the removable razor cartridge may be mounted to the housing between the cap and the guard. The guard and the cap may define a shaving plane that is tangent to the guard and the cap. The guard may be a solid or segmented bar that extends generally parallel to the at least one blade. The guard may comprise a skin-engaging member (e.g., a plurality of fins) in front of the blades for stretching the skin during a shaving stroke. The skin-engaging member may, for example, be insert injection molded or co-injection molded to the housing. Other known assembly methods may also be used such as adhering, bonding, attaching, ultrasonic welding, or mechanical fastening. The skin-engaging member may be molded from a softer material (i.e., lower durometer hardness) than the housing. For example, the skin-engaging member may have a Shore A hardness of about 20, 30, or 40 to about 50, 60, or 70. The skin-engaging member may be made from thermoplastic elastomers (TPEs) or rubbers; examples may include, but are not limited to silicones, natural rubber, butyl rubber, nitrile rubber, styrene butadiene rubber, styrene butadiene styrene (SBS) TPEs, styrene ethylene butadiene styrene (SEBS) TPEs (e.g., Kraton), polyester TPEs (e.g., Hytrel), polyamide TPEs (Pebax), polyurethane TPEs, polyolefin based TPEs, and blends of any of these TPEs (e.g., polyester/SEBS blend). In certain embodiments, the skin-engaging member may comprise Kraiburg HTC 1028/96, HTC 8802/37, HTC 8802/34, or HTC 8802/11 (KRAIBURG TPE GmbH & Co. KG of Waldkraiburg, Germany). A softer material for the skin-engaging member may enhance skin stretching, as well as provide a more pleasant tactile feel against the skin of the user during a shaving stroke. A softer material may also aid in masking the less pleasant feel of the harder material of the housing and/or the fins against the skin of the user during a shaving stroke.

The at least one blade may be mounted and secured to the housing by one or more clips. Other assembly methods known to those skilled in the art may also be used to secure and/or mount the at least one blade to the housing including, but not limited to, wire wrapping, cold forming, hot staking, insert molding, ultrasonic welding, and adhering. The clips may comprise a metal, such as aluminum for conducting heat and acting as a sacrificial anode to help prevent corrosion of the blades. The removable razor cartridge may have any number of blades depending on the desired performance and cost of the removable razor cartridge. The removable razor cartridge may have, for example, one blade, two blades, three blades, four blades, five blades, six blades, seven blades, or even more blades. As will be described in greater detail below, once the blades have become dulled (or damaged) the consumer may disengage the removable razor cartridge from the magnetic handle element and replace the used removable razor cartridge with a new removable razor cartridge.

The cap of the removable razor cartridge may be a separate molded or extruded component that is mounted to the housing. The cap may be, for example, a shaving aid filled reservoir or an extruded lubrication strip. The cap may be, for example, a plastic or metal bar to support the skin and define the shaving plane. The cap may be molded or extruded from the same material as the housing or may be molded or extruded from a more lubricious shaving aid composite that has one or more water-leachable shaving aid materials to provide increased comfort during a shave stroke.

The shaving aid composite may comprise a water-insoluble polymer and a skin-lubricating water-soluble polymer. Suitable water-insoluble polymers which may be used include, but are not limited to, polyethylene, polypropylene, polystyrene, butadiene-styrene copolymer (e.g., medium and high impact polystyrene), polyacetal, acrylonitrile-butadiene-styrene copolymer, ethylene vinyl acetate copolymer and blends such as polypropylene/polystyrene blend, may have a high impact polystyrene (i.e., Polystyrene-butadiene), such as Mobil 4324 (Mobil Corporation). Suitable skin lubricating water-soluble polymers may include polyethylene oxide, polyvinyl pyrrolidone, polyacrylamide, hydroxypropyl cellulose, polyvinyl imidazoline, and polyhydroxyethylmethacrylate. Other water-soluble polymers may include the polyethylene oxides generally known as POLYOX (available from Union Carbide Corporation) or ALKOX (available from Meisei Chemical Works, Kyota, Japan). These polyethylene oxides may have molecular weights of about 100,000 to 6 million, for example, about 300,000 to 5 million. The polyethylene oxide may comprise a blend of about 40 to 80% of polyethylene oxide having an average molecular weight of about 5 million (e.g., POLYOX COAGULANT) and about 60 to 20% of polyethylene oxide having an average molecular weight of about 300,000 (e.g., POLYOX WSR-N-750). The polyethylene oxide blend may also contain up to about 10% by weight of a low molecular weight (i.e., molecular weight of less than about 10,000) polyethylene glycol such as PEG-100.

The shaving aid composite may also include a complex of a skin-soothing agent with a cylcodextrin, low molecular weight water-soluble release enhancing agents such as polyethylene glycol (e.g., 1-10% by weight), water-swellable release enhancing agents such as cross-linked polyacrylics (e.g., 2-7% by weight), colorants, antioxidants, preservatives, microbicidal agents, beard softeners, astringents, depilatories, medicinal agents, conditioning agents, moisturizers, cooling agents, and the like.

The removable razor cartridge may exhibit a magnetic property or combination of magnetic properties. For example, the removable razor cartridge may comprise a permanent magnet, a dipole magnet, an electromagnet, a ferromagnetic material, a magnetized ferromagnetic material, a positive pole, a negative pole, or any combination thereof. The removable razor cartridge may, for example, exert an attractive magnetic force. The removable razor cartridge may, for example, be attracted by a magnetic force.

The removable razor cartridge may be of any suitable material that exhibits at least one of aforementioned magnetic properties. The removable razor cartridge may, for example, comprise at least one of iron, nickel, aluminum, cobalt, boron, alnico, ferrite, gadolinium, dysprosium, samarium, samarium-cobalt, neodymium-iron-boron, any alloy thereof, any ceramic thereof, or any combination thereof.

The removable razor cartridge may be of any suitable size and shape. For example, the removable razor cartridge may comprise a curved surface, a flat surface, or any combination thereof. The removable razor cartridge may also, for example, comprise a sphere, an ellipsoid, a cylinder, a quadrilateral, a parallelogram, a rectangle, a square, a bar, or any combination thereof. In addition, the removable razor cartridge may also be plated or coated (e.g., with plastic, rubber or nickel) to resist corrosion caused by the shaving environment.

The removable razor cartridge may have a handle mounting surface for engaging a corresponding surface on the at least one magnetic handle element of the handle. A direction of the force exerted by the removable razor cartridge or the magnetic element(s) may be generally transverse to a force applied to attach and to remove the removable razor cartridge to the handle. Accordingly, the attachment and removal forces of the removable razor cartridge can be reduced for consumer ease of use (compared to a magnetic force that is exerted in a direction parallel to the removal force). In addition, the force to attach and/or remove the removable razor cartridge may be more gradual. For example, a more sudden and larger force may be required if the force exerted by the magnetic elements are in a parallel direction as the attachment/removal force.

The removable razor cartridge may be attached to the handle by engaging the removable razor cartridge with the at least one magnetic handle element. The handle mounting surface may engage the housing mounting surface of the at least one magnetic handle element to temporarily secure the removable razor cartridge to the handle. The removable razor cartridge may be aligned with and magnetically attracted to the corresponding/opposing at least one magnetic handle element. The direction of the force between the opposing magnetic elements (e.g., between the removable razor cartridge and the at least one magnetic handle element) may be generally transverse to the force required to remove and attach the removable razor cartridge with the at least one magnetic handle element (e.g., which may be generally parallel to the elongated gripping portion of the handle).

The handle may, for example, include two magnetic handle elements. The two magnetic handle elements may exert an attractive magnetic force on the removable razor cartridge. The removable razor cartridge may be attracted to the magnetic force that is exerted by the two magnetic handle elements. The removable razor cartridge may connect to the handle when the handle is brought in proximity to the removable razor cartridge. This configuration facilitates, inter alia, quick, easy, intuitive, and safe connection of the removable razor cartridge to the handle.

The handle may, for example, include two magnetic handle elements. The removable razor cartridge may exhibit both an attractive magnetic force and be attracted to a magnetic force. One magnetic handle element may exert an attractive magnetic force and the corresponding/opposing section of the removable razor cartridge may be attracted to the magnetic force. The other magnetic handle element may be attracted to the corresponding/opposing section of the removable razor cartridge that exerts the attractive magnetic force. The removable razor cartridge may connect to the handle when the handle is brought in proximity to the removable razor cartridge and when the attractive magnetic handle element and removable razor cartridge section are aligned with the attractable removable razor cartridge section and magnetic handle element. This configuration prevents, inter alia, reverse connection of the removable razor cartridge to the handle. The configuration also facilitates, inter alia, quick, easy, intuitive, and safe connection of the removable razor cartridge to the handle.

The removable razor cartridge may also include a heater bar. The heater bar may comprise aluminum, copper, gold, steel, brass, nickel, any alloys thereof, and any combination thereof. In addition, the clips may be positioned within notches that are located on the heater bar. The clips may comprise any metal that has good thermal conduction properties. The clips may comprise aluminum, copper, gold, steel, brass, nickel, any alloys thereof, and any combination thereof. The notches may facilitate the transfer of heat to the clips (e.g., the heater bar may contact the clips through the notches). Accordingly, heat may be transferred not only just in front of the blades, but also on both sides of the blades along with the skin-engaging member and/or the guard. Furthermore, since the blades and the contact clips may comprise metal, heat may also be transferred from the clips to the blades. This configuration may optimize the amount of heat transferred to the surface of the skin during a shaving stroke. The skin contacting surface of the heater bar may be positioned substantially adjacent to the skin-engaging member and/or the guard. Accordingly, the skin contacting surface of the heater bar, the skin-engaging member, and/or the guard may all contact the skin surface of the user during a shaving stroke (e.g., may all be on the same plane).

The removable razor cartridge may pivot between limits and ordinarily may be biased toward a preferred neutral angular position vis-a-vis the handle. The pivot limits and biasing may be accomplished by any means known in the art, including mechanical limits.

The shaving razor system may include an electrical circuit to which current is supplied by a power source (e.g., such as one or more disposable or rechargeable batteries) through a contact. The electrical circuit and the power source may be positioned within the handle. The electrical circuit may be closed by a switch, which may be actuated when the user pushes a button. The electrical circuit may provide power for additional features within the shaving system. The electrical circuit may, for example, provide power for heat generation, vibration, and any other feature requiring an electrical current. The handle may include a light emitting diode (LED). The LED may indicate to the user that the power to the circuit has been turned on or off. The LED may be disposed in a transparent area of the handle or may extend through an opening in the handle. The LED may indicate whether the heater bar is warm or warming, whether the heater bar is too hot, the removable razor cartridge needs to be replaced, and other properties of the shaving razor system.

The at least one magnetic handle element may be released from the removable razor cartridge by the exertion of force as is described above. In addition, the at least one magnetic handle element may be released by other suitable mechanisms or by other suitable mechanisms in combination with the exertion of force.

The at least one magnetic handle element may be released from the removable razor cartridge via, for example, an electrical release. The at least one magnetic handle element may have an electromagnetic property. The at least one magnetic handle element may exhibit a magnetic force when an electrical current is applied to the at least one magnetic handle element. The at least one magnetic handle element may be in electrical connection with an electric circuit that may be within, for example, the handle. The electric current may be provided by, for example, at least one battery that is located within the handle and in electrical connection with the electric circuit through a contact. The electrical circuit may include a switch that, when actuated by the user, provides an electrical current to the at least one magnetic handle element. The at least one magnetic handle element may then exert, for example, an attractive magnetic force. The removable razor cartridge may be attracted to the magnetic force exerted by the at least one magnetic handle element. The at least one magnetic handle element may then connect to the removable razor cartridge. The user may electrically release the removable razor cartridge from the at least one magnetic handle element by actuating the switch a second time. The electrical current will no longer flow through the at least one magnetic handle element. The at least one magnetic handle element will no longer exert the attractive magnetic force. The removable razor cartridge will no longer connect with the at least one magnetic handle element. The removable razor cartridge may then be released from the handle.

The at least one magnetic handle element may be released from the removable razor cartridge via, for example, a mechanical release. The at least one magnetic handle element may have a permanent magnet property. The at least one magnetic handle element may exert, for example, an attractive magnetic force. The removable razor cartridge may be attracted to the magnetic force exerted by the at least one magnetic handle element. The at least one magnetic handle element may then connect to the removable razor cartridge. The at least one magnetic handle element may be connected to, for example, one end of a mechanical release apparatus and a switch may be connected to the other end of the mechanical release apparatus. The mechanical release apparatus may, for example, extend from the proximal end portion of the handle to the switch that may be included within the gripping portion of the handle. The user may mechanically release the removable razor cartridge from the at least one magnetic handle element by actuating the switch. The mechanical release apparatus may then, for example, pull back on the at least one magnetic handle element. The attractive magnetic force that is exerted by the at least one magnetic handle element on the removable razor cartridge may not be strong enough to remain connected to the removable razor cartridge. The removable razor cartridge will no longer connect with the at least one magnetic handle element. The removable razor cartridge may then be released from the handle.

Referring to FIG. 1, a perspective view of a shaving razor system 10 is shown. The shaving razor system 10 includes a handle 12 and a removable razor cartridge 30. The handle 12 includes an elongated gripping portion 14, a proximal end portion 16, a distal end portion 18, and a magnetic handle element 20. The magnetic handle element 20 is in pivotable relation to the proximal end portion 16 of the handle via a revolute joint. The magnetic handle element 20 may pivot about an axis that is generally transverse to the handle 12. The removable razor cartridge 30 includes a housing 32, a guard 34, a cap 36, and at least one blade 38. The removable razor cartridge 30 is in pivotable relation to the proximal end portion 16 of the handle 12 when in connection with the magnetic handle element 20. The removable razor cartridge 30 may pivot about an axis that is generally transverse to the handle 12.

Referring to FIG. 2, another perspective view of a shaving razor system 10 of FIG. 1 is shown. The shaving razor system 10 includes a handle 12 and a removable razor cartridge 30. The handle 12 includes an elongated gripping portion 14, a proximal end portion 16, a distal end portion 18, and a magnetic handle element 20. The housing 32 includes a section that has a generally flat shape opposite the shaving plane of the removable razor cartridge 30. The magnetic handle element 20 is in pivotable relation to the proximal end portion 16 of the handle via a revolute joint. The magnetic handle element 20 may pivot about an axis that is generally transverse to the handle 12. The removable razor cartridge 30 includes a housing 32, a guard 34, a cap 36, and at least one blade 38. The removable razor cartridge 30 may exert an attractive force on the magnetic handle element 20. Alternatively, the magnetic handle element 20 may exert an attractive force on the removable razor cartridge 30. The removable razor cartridge 30 is releasably engaged with the magnetic handle element 20 to replaceably secure the removable razor cartridge 30 to the proximal end portion 16 of the handle 12.

Referring to FIG. 3, a perspective view of a shaving razor system 10 is shown. The shaving razor system 10 includes a handle 12 and a removable razor cartridge 30. The handle 12 includes an elongated gripping portion 14, a proximal end portion 16, a distal end portion 18, a first magnetic handle element 22, and a second magnetic handle element 24. The proximal end portion 16 of the handle 12 includes a first arm 50 and a second arm 52. The first and second magnetic handle elements 22,24 are in pivotable relation to the proximal end portion 16 of the handle 12 via revolute joints. The first and second magnetic handle elements 22,24 may pivot about an axis that is generally transverse to the handle 12. The removable razor cartridge 30 includes a housing 32, a guard 34, a cap 36, and at least one blade 38. The housing 32 includes a section that has a generally flat shape opposite the shaving plane of the removable razor cartridge 30. The removable razor cartridge 30 may exert an attractive force on the magnetic handle elements 22,24. Alternatively, the magnetic handle elements 22,24 may exert an attractive force on the removable razor cartridge 30. Alternatively, the first magnetic handle element 22 may exert an attractive force on the opposing section of the removable razor cartridge 30 and the second magnetic handle element 24 may be attracted to the opposing section of the removable razor cartridge 30. The removable razor cartridge 30 is releasably engaged with the magnetic handle elements 22,24 to replaceably secure the removable razor cartridge 30 to the proximal end portion 16 of the handle 12.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor system comprising:
a handle, the handle comprising a proximal end portion, a distal end portion, and at least one magnetic handle element that is in pivotable relation to the proximal end portion;
a removable razor cartridge, the removable razor cartridge comprising a housing, a guard, a cap, and at least one blade;
wherein the removable razor cartridge is releasably engaged with the at least one magnetic handle element to replaceably secure the removable razor cartridge to the proximal end portion of the handle.

2. The shaving razor system of claim 1 wherein the at least one magnetic handle element comprises a permanent magnet, a dipole magnet, an electromagnet, a ferromagnetic material, a magnetized ferromagnetic material, a positive pole, a negative pole, or any combination thereof.

3. The shaving razor system of claim 1 wherein the removable razor cartridge comprises a permanent magnet, a dipole magnet, an electromagnet, a ferromagnetic material, a magnetized ferromagnetic material, a positive pole, a negative pole, or any combination thereof.

4. The shaving razor system of claim 1 wherein the handle includes a first magnetic handle element and a second magnetic handle element.

5. The shaving razor system of claim 1 wherein the at least one magnetic handle element comprises at least one of iron, nickel, aluminum, cobalt, boron, alnico, ferrite, gadolinium, dysprosium, samarium, samarium-cobalt, neodymium-iron-boron, any alloy thereof, any ceramic thereof, or any combination thereof.

6. The shaving razor system of claim 1 wherein the removable razor cartridge comprises at least one of iron, nickel, aluminum, cobalt, boron, alnico, ferrite, gadolinium, dysprosium, samarium, samarium-cobalt, neodymium-iron-boron, any alloy thereof, any ceramic thereof, or any combination thereof.

7. The shaving razor system of claim 1 wherein the at least one magnetic handle element is released from the removable razor cartridge via an electrical release, a mechanical release, or any combination thereof.

8. The shaving razor system of claim 1 wherein the at least one magnetic handle element comprises a curved surface, a flat surface, or any combination thereof.

9. The shaving razor system of claim 1 wherein the at least one magnetic handle element comprises a sphere, an ellipsoid, a cylinder, or any combination thereof.
